(19) United States
(12) Patent Application Publication
(10) Pub. No.: US 2010/0290228 A1
(43) Pub. Date: Nov. 18, 2010

(54) ILLUMINATION DEVICE WITH SPHERICAL SURFACE

(75) Inventors: JYH-LONG CHERN, Chu-Nan (TW); AN-CHI WEI, Chu-Nan (TW); CHIH-MING LAI, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/538,256

(22) Filed: Aug. 10, 2009

(30) Foreign Application Priority Data
May 13, 2009 (CN) 200910302263.7

(51) Int. Cl. F21S 4/00

(52) U.S. Cl. 362/249.02

(57) ABSTRACT

An exemplary illumination device includes a base, a first solid-state light source, and a number of second solid-state light sources. The base has a spherical surface. The spherical surface defines a spherical center and a base central axis passing through the spherical center. The first solid-state light source defines a first light source central axis coaxial with the base central axis of the spherical surface. The second solid-state light sources are mounted over the spherical surface. Each of the second solid-state light sources defines a second light source central axis passing through the spherical center of the spherical surface. Light intensities of the first solid-state light source and each second solid-state light source satisfy the formula: I=I₀/cos³ θ, wherein I₀ is the light intensity of the first solid-state light source, and I is the light intensity of each second solid-state light source.

### BACKGROUND

1. Technical Field

The disclosure generally relates to illumination devices, and particularly to an illumination device having a base with a spherical surface.

2. Description of Related Art

Light emitting diodes (LEDs) have recently been extensively used as light sources for illumination devices due to their high luminous efficiency, low power consumption and long lifespan. A single LED generally has a limited radiating range. To achieve a large radiating range, some illumination devices employ a plurality of LEDs on a base. However, such illumination devices may not achieve uniform light output. Therefore the range of applications suitable for these illumination devices is limited.

Thus, what is needed is an illumination device that overcomes the described limitations.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view of an illumination device according to a first embodiment, as seen from a position above the illumination device. [0006] FIG. 2 is a cross section of the illumination device of FIG. 1, taken from line II-II thereof.

FIG. 3 is a top plan view of the illumination device of FIG. 1.

FIG. 4 is a diagram illustrating light intensity distribution of the illumination device of FIG. 1.

FIG. 5 is an isometric view of an illumination device according to a second embodiment, as seen from a position below the illumination device.

### DETAILED DESCRIPTION

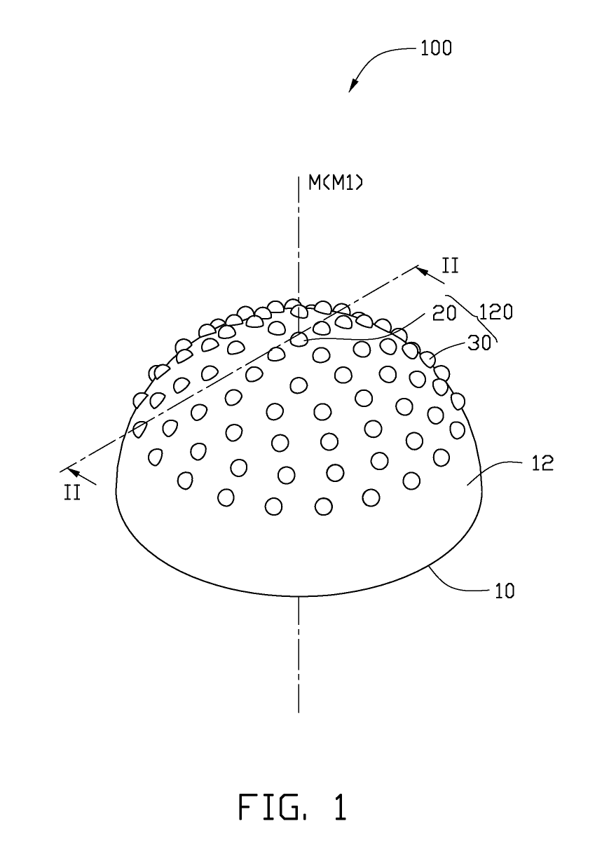

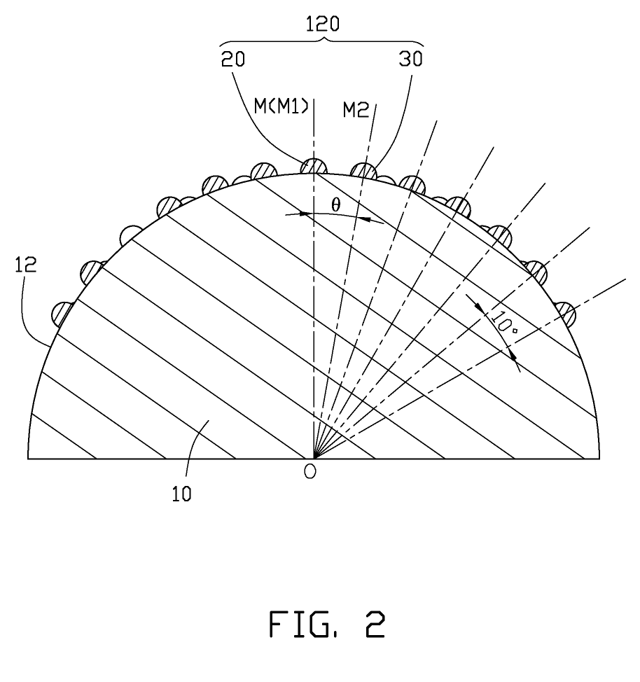

Referring to FIGS. 1 and 2, an illumination device 100, according to a first embodiment, includes a base 10, a first solid-state light source 20, and a plurality of second solid-state light sources 30.

In this embodiment, the base 10 is solid and has a hemispherical shape. The base 10 has a spherical surface 12 for mounting the first and second solid-state light sources 20, 30 thereon. The spherical surface 12 has a spherical center O, and a base central axis M passing through the spherical center O. The spherical surface 12 is thus a hemispherical surface.

The first and second solid-state light sources 20, 30 may be LEDs or LED chips. In this embodiment, the first and second solid-state light sources 20, 30 are all LEDs. The first light source 20 has a first light source central axis M1. Each of the second light sources 30 has a second light source central axis M2.

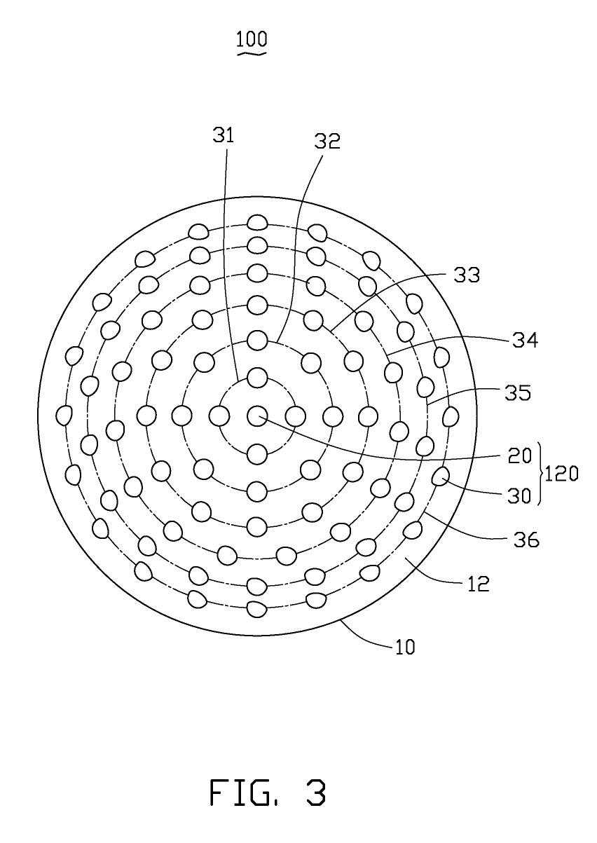

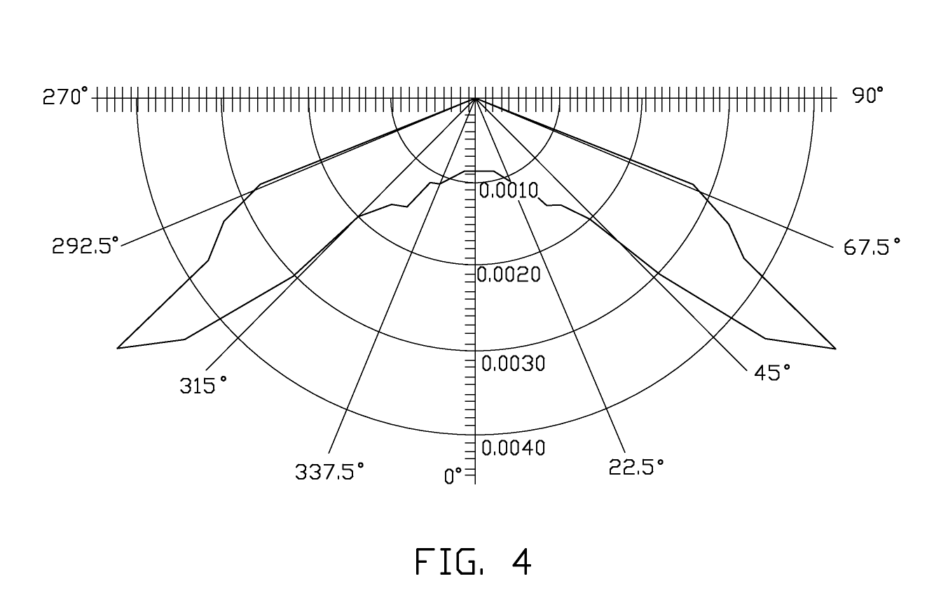

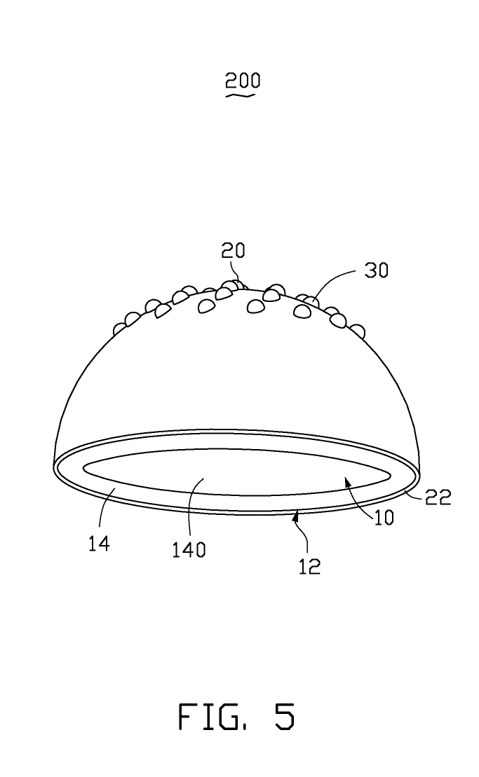

Referring also to FIG. 3, the first solid-state light source 20 is mounted on the spherical surface 12 at a position corresponding to a vertex of the spherical surface 12. The first light source central axis M1 of the first solid-state light source 20 is coaxial with the base central axis M of the spherical surface 12. The second solid-state light sources 30 are mounted on the spherical surface 12 around the base central axis M. In a typical application, the second solid-state light sources 30 are evenly distributed along at least one imaginary circle on the spherical surface 12, with the center of the at least one imaginary circle being on the base central axis M. That is, on each of the at least one imaginary circle, the second solid-state light sources 30 are substantially evenly spaced apart from one another. The at least one imaginary circle can be considered as at least one parallel of latitude of the spherical surface 12. In this embodiment, the at least one imaginary circle includes six neighboring imaginary circles, such as a first imaginary circle 31, a second imaginary circle 32, a third imaginary circle 33, a fourth imaginary circle 34, a fifth imaginary circle 35, and a sixth imaginary circle 36. The first, the second, the third, the fourth, the fifth, and the sixth imaginary circles 31-36 are arranged in sequence parallel to each other, with their centers located along the base central axis M of the spherical surface 12. The first imaginary circle 31 is the one nearest to the vertex of the spherical surface 12.

The first, the second, the third, the fourth, the fifth, and the sixth imaginary circles 31-36 have different numbers of second solid-state light sources 30 arranged thereon. The number of second solid-state light sources 30 on each imaginary circle 31-36 increases with increasing radius of the imaginary circles 31-36. Thus, all the second solid-state light sources 30 cooperate with the first solid-state light source 20 to form an illuminating region 120, in which the first and second solid-state light sources 20, 30 are approximately evenly distributed. In this embodiment, the first imaginary circle 31 has four second solid-state light sources 30 arranged thereon. The second imaginary circle 32 has eight second solid-state light sources 30 arranged thereon. The third imaginary circle 33 has twelve second solid-state light sources 30 arranged thereon. The fourth imaginary circle 34 has fifteen second solid-state light sources 30 arranged thereon. The fifth imaginary circle 35 has eighteen second solid-state light sources 30 arranged thereon, and the sixth imaginary circle 35 has twenty second solid-state light sources 30 arranged thereon.

The second light source central axis M2 of each second solid-state light source 30 passes through the spherical center O of the spherical surface 12. An angle θ is defined between each second light source central axis M2 and the base central axis M. Since the center of each imaginary circle is at the base central axis M, the angle θ defined by the second light source central axis M2 of one second solid-state light source 30 on a given imaginary circle 31˜36 is equal to that of any other second solid-state light source 30 on the same imaginary circle 31˜36. In this embodiment, the angle θ between the second light source central axis M2 of any one of the second solid-state light sources 30 on the first imaginary circle 31 and the base central axis M is ten degrees. In addition, the angle θ defined by the second light source central axis M2 of any second solid-state light source 30 on any one of the imaginary circles 31˜36 (e.g., the second imaginary circle 32) is different from the angle θ defined by the second light source central axis M2 of any second solid-state light source 30 on either of the neighboring imaginary circles 31˜36 (e.g., the first imaginary circle 31 or the third imaginary circle 33). The difference between the two angles 0 is ten degrees.

The light intensities of the first solid-state light source 20 and each second solid-state light source 30 satisfy the formula: I=I₀/cos³ θ, wherein I₀ is the light intensity of the first solid-state light source 20, and I is the light intensity of each second solid-state light source 30.

In one example, the light intensity I₀ of the first solid-state light source 20 is 0.00524 candelas (cd). In such case, the second solid-state light sources 30 should satisfy the following conditions in Table 1 in order that the illumination device 100 provides uniform illumination.

TABLE 1

| | light intensity I of each | The number of |
|---|---|---|
| | second solid-state | second solid-state |
| | light source | light sources on |
| Angle θ (degrees) | on a given imaginary circle (cd) | the imaginary circle |
| 60 | 0.04189 | 20 |
| 50 | 0.01972 | 18 |
| 40 | 0.01165 | 15 |
| 30 | 0.00806 | 12 |
| 20 | 0.00631 | 8 |
| 10 | 0.00548 | 4 |

FIG. 4 shows that the Full Width at Half Maximum (FWHM) of the illumination device 100 is in a range from about 0 degrees to about 67.5 degrees, and also in a range from about 292.5 degrees to about 360 degrees. That is, the FWHM of the illumination device 100 is about 135 degrees. In addition, the light intensity distribution in the FWHM is substantially uniform. Therefore, the illumination device 100 has a large radiating range and can provide substantially uniform output light. The illumination device 100 may be applied in locations where a large radiating range and uniform light is needed, such as a dancing stage.

The base 10 can be made of insulating material, such as plastic. Alternatively, the base 10 can be made of metallic material with high thermal conductivity, such as aluminum, copper, aluminum-copper alloy, or other suitable metallic materials. When the base 10 is made of metallic material, heat dissipation from the first and second solid-state light sources 20, 30 is enhanced.

FIG. 5 illustrates an illumination device 200, according to a second embodiment. The illumination device 200 is similar to the illumination device 100 of the first embodiment. However, for illumination device 200, the base 10 defines an annular bottom surface 14 which adjoins the spherical surface 12. A cavity 140 is defined in the base 10 at the bottom surface 14. A flexible circuit board 22 is attached on the spherical surface 12, and the first and second solid-state light sources 20, 30 are mounted on the flexible circuit board 22.

The provision of the cavity 140 in the base 10 reduces the amount of material needed for the base 10. The flexible circuit board 22 may be a Flexible Printed Circuit (FPC). A substrate of the flexible circuit board 22 may be made of, for example, a mixture of graphite and polyester (such as polyethylene terephthalate-PET), or a mixture of graphite and polyimide (PI). With this configuration, heat from the first and second solid-state light sources 20, 30 can be transferred to the base 10 via the flexible circuit board 22, and thence be dissipated to ambient air. Accordingly, the first and second solid-state light sources 20, 30 may operate continuously within an acceptable temperature range and thereby achieve stable optical performance. In particular, the brightness and the luminous efficiency of the first and second solid-state light sources 20, 30 can be stably maintained.

It is noted that in other embodiments, a larger number of second solid-state light sources 30 may be arranged on the spherical surface 12, as long as the light intensity I of each second solid-state light source 30 follows the formula: I=I₀/cos³ θ. In such case, the first and second solid-state light sources 20, 30 may be distributed on the spherical surface 12 more evenly. Thereby, the illumination device 100, 200 can provide more uniform output light.

It is to be understood that the above-described embodiments are intended to illustrate rather than limit the disclosure. Variations may be made to the embodiments without departing from the spirit of the disclosure. The above-described embodiments illustrate the scope of the disclosure but do not restrict the scope of the disclosure.

What is claimed is:

1. An illumination device, comprising:
a base having a spherical surface, the spherical surface defining a spherical center and a base central axis passing through the spherical center;
a first solid-state light source mounted over the spherical surface, the first solid-state light source defining a first light source central axis, the first light source central axis being coaxial with the base central axis of the spherical surface; and
a plurality of second solid-state light sources mounted over the spherical surface, each of the second solid-state light sources defining a second light source central axis passing through the spherical center of the spherical surface, and all the second solid-state light sources cooperating with the first solid-state light source to form an illuminating region in which the first and second solid-state light sources are substantially evenly distributed, light intensities of the first solid-state light source and each second solid-state light source satisfying the formula: I=I₀/cos³ θ, wherein I₀ is the light intensity of the first solid-state light source, and I is the light intensity of each second solid-state light source.

2. The illumination device of claim 1, further comprising a circuit board attached on the spherical surface of the base, the first and second solid-state light sources being mounted on the circuit board.

3. The illumination device of claim 2, wherein the circuit board comprises a flexible printed circuit.

4. The illumination device of claim 3, wherein a substrate of the flexible printed circuit is comprised of one of a mixture of graphite and polyester, and a mixture of graphite and polyimide.

5. The illumination device of claim 1, wherein the second solid-state light sources are evenly distributed along at least one imaginary circle on the spherical surface, with the center of the at least one imaginary circle being on the base central axis.

6. The illumination device of claim 5, wherein the at least one imaginary circle comprises a plurality of imaginary circles arranged in sequence parallel to each other, and the number of second solid-state light sources on each imaginary circle increases with increasing radius of the imaginary circles.

7. The illumination device of claim 6, wherein an angle of declination is defined between the second light source central axis of each second solid-state light source and the base central axis of the spherical surface, the angle of declination defined by any second solid-state light source on any one of the imaginary circles is different from the angle of declination defined by any second solid-state light source on either of the neighboring imaginary circles, and the difference between the two angles of declination is approximately ten degrees.

8. The illumination device of claim 7, wherein the angle defined by the base central axis of the spherical surface and the second light source central axis of any second solid-state light source on a nearest imaginary circle to the vertex of the spherical surface is approximately ten degrees.

9. The illumination device of claim 1, wherein the base has a hemispherical shape, and the spherical surface is a hemispherical surface.

10. The illumination device of claim 9, wherein the base defines an annular bottom surface adjacent to the spherical surface, and a cavity at the bottom surface.

11. The illumination device of claim 1, wherein each of the first and second solid-state light sources comprises one of a light emitting diode and a light emitting diode chip.

12. The illumination device of claim 1, wherein the base is made of metallic material.

13. The illumination device of claim 12, wherein the metallic material comprises one of aluminum, copper and aluminum-copper alloy.

14. The illumination device of claim 1, wherein the first and second solid-state light sources are directly attached on the spherical surface of the base.

15. An illumination device, comprising:
a base having a spherical surface, the spherical surface defining a spherical center and a base central axis passing through the spherical center;
a first solid-state light source mounted over the spherical surface, the first solid-state light source defining a first light source central axis, the first light source central axis being coaxial with the base central axis of the spherical surface; and
a plurality of second solid-state light sources mounted over the spherical surface and evenly distributed along at least one parallel of latitude on the spherical surface, with the center of the at least one parallel of latitude being on the base central axis, each of the second solid-state light sources defining a second light source central axis passing through the spherical center of the spherical surface, and all the second solid-state light sources cooperating with the first solid-state light source to form an illuminating region in which the first and second solid-state light sources are substantially evenly distributed, light intensities of the first solid-state light source and each second solid-state light source satisfying the formula: I=I₀/cos³ θ, wherein I₀ is the light intensity of the first solid-state light source, and I is the light intensity of each second solid-state light source.

16. The illumination device of claim 15, wherein the at least one parallel of latitude comprises a plurality of parallels of latitude arranged in sequence parallel to each other, and the number of second solid-state light sources on each parallel of latitude increases with increasing radius of the parallels of latitude.

17. The illumination device of claim 16, wherein an angle of declination is defined between the second light source central axis of each second solid-state light source and the base central axis of the spherical surface, the angle of declination defined by any second solid-state light source on any one of the parallels of latitude is different from the angle of declination defined by any second solid-state light source on either of the neighboring parallels of latitude, and the difference between the two angles of declination is approximately ten degrees.

18. The illumination device of claim 17, wherein the angle of declination defined by any second solid-state light source on the imaginary circle nearest to the vertex of the spherical surface is approximately ten degrees.

19. The illumination device of claim 15, wherein the first and second solid-state light sources are directly attached on the spherical surface of the base.

20. The illumination device of claim 15, further comprising a circuit board attached on the spherical surface of the base, the first and second solid-state light sources being mounted on the circuit board.
